(19) United States
(12) Patent Application Publication
(10) Pub. No.: US 2021/0210912 A1
(43) Pub. Date: Jul. 8, 2021

(54) ANTENNA BOX MODULE, CONNECTOR MODULE AND COAXIAL CABLE

(71) Applicant: Taoglas Group Holdings Limited, Enniscorthy (IE)

(72) Inventors: Tsai-Yi Yang, Tainan City (TW); Ching-Wen Wu, Tainan City (TW)

(21) Appl. No.: 17/141,998

(22) Filed: Jan. 5, 2021

(30) Foreign Application Priority Data
Jan. 6, 2020 (TW) 109100363

(51) Int. Cl. H01R 24/40; H01Q 1/22; H01R 13/639; H01B 11/18

(52) U.S. Cl. CPC H01R 24/40; H01Q 1/22; H01R 2201/02; H01B 11/18; H01R 13/639

(57) ABSTRACT

An antenna box module comprising a circuit board and a connector module is provided. The circuit board has an antenna. The connector module comprises a first connector, a coaxial cable body and a second connector. The first connector comprises a first clip-locking portion and a first body. The first body has a tube shape and extends in a direction. The first clip-locking portion is disposed at the first body and an end of the first clip-locking portion is adapted for being elastically deformed perpendicularly to the direction. An end of the coaxial cable body passes through the first body of the first connector. The second connector comprises a second clip-locking portion and a second body. The second clip-locking portion is disposed at the second body and adapted for locking the first clip-locking portion of the first connector. The second body is disposed at the circuit board and electrically connected to the antenna. In addition, a connector module and a coaxial cable are also provided.

### PRIORITY

This application claims the benefit of priority to Taiwanese Patent Application No. 109100363 filed on Jan. 6, 2020 of the same title, the contents of which being incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE DISCLOSURE

### 1. Technological Field

The present disclosure is related to a coaxial cable, and in particular to a connector module with the coaxial cable and an antenna module with the connector module.

### 2. Field of the Disclosure

A conventional antenna box module includes at least one antenna and a circuit board, wherein the antenna is disposed on the circuit board, and a connector may be further configured on the circuit board. In order to transmit signals of the antenna to another device, the conventional antenna box module may be connected to the other device through a connection wire. Regarding the connection between the connection wire and the antenna box module, an end of the connection wire is provided with an end connector for coupling to the connector on the circuit board in the antenna box module.

In the prior art, a method for assembling and joining the connector on the circuit board in the antenna box module and the end connector at the end of the connection wire is achieved by means of screw locking, which is both labor and time consuming.

### SUMMARY

The present disclosure satisfies the foregoing needs by providing, inter alia, an antenna box module, a connector module and coaxial cable that may be assembled and joined in a more labor-friendly and timely manner.

One object of the present disclosure is to provide an antenna box module, a connector and a coaxial cable, so that the assembly method between connectors may become more labor and time saving.

The present disclosure provides an antenna box module comprising a circuit board and a connector module. The circuit board having an antenna. The connector module comprises a first connector, a second connector and a coaxial cable body. The first connector comprises a first clip-locking portion and a first body. The first body has a tube shape and extends in a direction. The first clip-locking portion is disposed at the first body and an end of the first clip-locking portion is adapted for being elastically deformed perpendicularly to the direction. The second connector comprises a second clip-locking portion and a second body. The second clip-locking portion is disposed at the second body and adapted for locking the first clip-locking portion. An end of the coaxial cable body passes through only one of the first body and the second body, and the other of the first body and the second body is disposed at the circuit board and electrically connected to the antenna.

In an embodiment of the present disclosure, the first clip-locking portion has a plurality of locking hooks, the locking hooks are disposed at an edge of the first body, and a gap is maintained between neighboring two of the locking hooks.

In an embodiment of the present disclosure, the second clip-locking portion is a protrusion disposed at an inner side of a tube structure of the second body.

In an embodiment of the present disclosure, the connector module comprises a plurality of first connectors and a plurality of second connectors, and the first connectors are fixed at a common body to be arranged in an array and/or the second connectors are fixed at another common body to be arranged in an array.

The present disclosure also provides a connector module comprises a first connector, a second connector and a coaxial cable body. The first connector comprises a first clip-locking portion and a first body. The first body has a tube shape and extends in a direction. The first clip-locking portion is disposed at the first body and an end of the first clip-locking portion is adapted for being elastically deformed perpendicularly to the direction. The second connector comprises a second clip-locking portion and a second body. The second clip-locking portion is disposed at the second body and adapted for locking the first clip-locking portion. An end of the coaxial cable body passes through only one of the first body and the second body, and the other of the first body and the second body is adapted for being disposed at a circuit board.

In an embodiment of the present disclosure, the first clip-locking portion has a plurality of locking hooks, the locking hooks are disposed at an edge of the first body, and a gap is maintained between neighboring two of the locking hooks.

In an embodiment of the present disclosure, the second clip-locking portion is a protrusion disposed at an inner side of a tube structure of the second body.

In an embodiment of the present disclosure, the connector module comprises a plurality of first connectors and a plurality of second connectors. The first connectors are fixed at a common body to be arranged in an array and/or the second connectors are fixed at another common body to be arranged in an array.

The present disclosure further provides a coaxial cable comprising a first connector and a coaxial cable body. The first connector comprises a first clip-locking portion and a first body. The first body has a tube shape and extends in a direction. The first clip-locking portion is disposed at the first body and an end of the first clip-locking portion is adapted for being elastically deformed perpendicularly to the direction. An end of the coaxial cable body passes through the first body.

In an embodiment of the present disclosure, the first clip-locking portion has a plurality of locking hooks, the locking hooks are disposed at an edge of the first body, and a gap is maintained between neighboring two of the locking hooks.

In an embodiment of the present disclosure, the coaxial cable comprises a plurality of first connectors. The first connectors are fixed at a common body to be arranged in an array.

Other features and advantages of the present disclosure will immediately be recognized by persons of ordinary skill in the art with reference to the attached drawings and detailed description of exemplary implementations as given below.

### BRIEF DESCRIPTION OF THE DRAWINGS

The features, objectives, and advantages of the present disclosure will become more apparent from the detailed description set forth below when taken in conjunction with the drawings, wherein:

FIG. 1 shows a top schematic diagram of an antenna box module according to an embodiment of the present disclosure, wherein an antenna box is coupled to a connector module.

FIG. 2 shows a three-dimensional schematic diagram of the coaxial cable depicted in FIG. 1.

FIG. 3 shows a three-dimensional schematic diagram of the second connector depicted in FIG. 1.

All Figures disclosed herein are © Copyright 2020

Taoglas Group Holdings Limited. All rights reserved.

### EXEMPLARY EMBODIMENTS

Detailed descriptions of the various embodiments and variants of the apparatus and methods of the present disclosure are now provided. It is noted that wherever practicable similar or like reference numbers may be used in the figures and may indicate similar or like functionality. The figures depict embodiments of the disclosed system (or methods) for purposes of illustration only. One skilled in the art will readily recognize from the following description that alternative embodiments of the structures and methods illustrated herein may be employed without necessarily departing from the principles described herein.

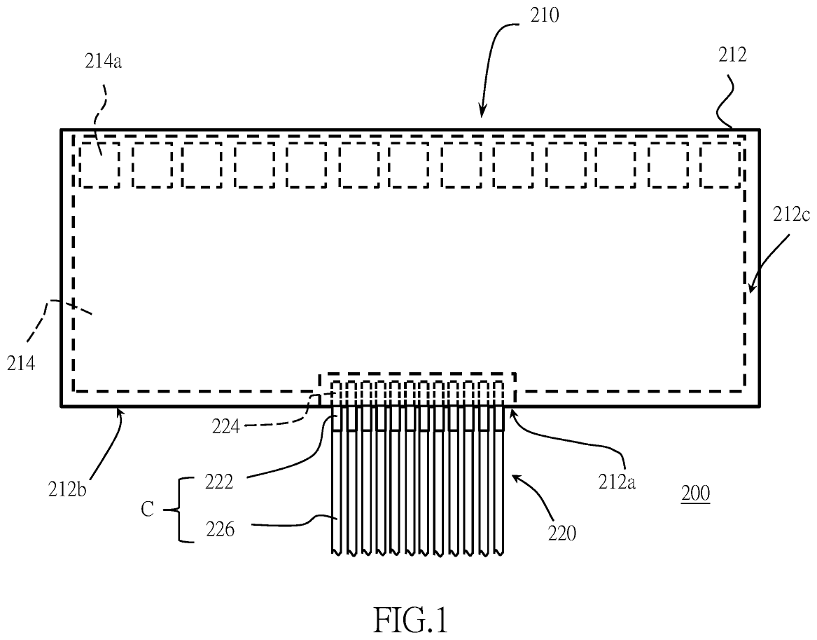

FIG. 1 shows a top schematic diagram of an antenna box module according to an embodiment of the present disclosure, wherein an antenna box is coupled to a connector module.

Referring to FIG. 1, an antenna box module 200 of this embodiment includes an antenna box 210 and a connector module 220. The antenna box 210 includes a housing 212 and a circuit board 214 disposed in the housing 212. The circuit board 214 has multiple antennas 214a. Each of the antennas 214a is adapted for receiving and transmitting multiple wireless signals according to one of multiple wireless communication standards. In some implementations, the antennas 214a are in different types from one another, for example, being based on different wireless communication standards from one another, and so the antennas 214a may have respective corresponding structures. The wireless communication standards include, for example, the Wi-Fi wireless communication standard, Bluetooth wireless communication standard, GPS wireless communication standard, 2G wireless communication standard, 3G wireless communication standard, 4G wireless communication standard, 5G wireless communication standard and WiMAX wireless communication standard. In some implementations, all or a portion of the antennas 214a may operate in conjunction with one another such as, for example, in a multiple-in multiple-out (MIMO) type antenna arrangement.

The connector module 220 may include one or more first connectors 222, one or more second connectors 224, and one or more coaxial cable bodies 226. During use, one end of one coaxial cable body 226 is connected or otherwise attached to one first connector 222 to form a coaxial cable C, further allowing the first connector 222 to be coupled and electrically connected to one second connector 224. Thus, the numbers of the first connectors 222, the coaxial cable bodies 226 and the second connectors 224 are not limited; however, the numbers of the first connectors 222, the coaxial cable bodies 226 and the second connectors 224 may be the same.

The second connectors 224 may be disposed on the circuit board 214 by, for example but not limited to, using a surface-mount technology (SMT) type connection, although it would be appreciated that other types of connections, such as through-hole mounting, may be utilized in alternative variants. By wires or traces (not shown) on the circuit board 214, each of the second connectors 224 may be electrically connected to one or more of the antennas 214a. Thus, the antennas 214a may be electrically connected to one coaxial cable body 226 through the coupling between one second connector 224 and the corresponding first connector 222, so as to transmit (and/or receive) signals (e.g., Wi-Fi signals) of the antenna 214a to/from an external device (not shown). Another antenna 214a may be electrically connected to another coaxial cable body 226 through the coupling between another second connector 224 and another corresponding first connector 222, to transmit (and/or receive) signals (e.g., 4G signals) of the other antenna 214a to/from another external device (not shown).

In some embodiments, the antennas 214a are all antennas in the antenna box 210. In other words, all antennas (i.e., the antennas 214a) in the antenna box 210 may be altogether coupled to the exterior through the second connectors 224 without other additionally provided connectors. The antennas 214a and the coaxial cables C may be in one-to-one correspondence; that is, the number of the antennas 214a may be the same as the number of the coaxial cables C and each of the coaxial cables C may be electrically connected to only one of the antennas 214a in some implementations.

The housing 212 may have an opening 212a, and a part of each of the second connectors 224 is exposed outside the housing 212 through the opening 212a. The material of the housing 212 of the antenna box 210 may include a heat-resistant material such as, for example, a plastic, and may be, for example, a mixture of polyamide (PA) resin and acrylonitrile butadiene styrene (ABS) resin.

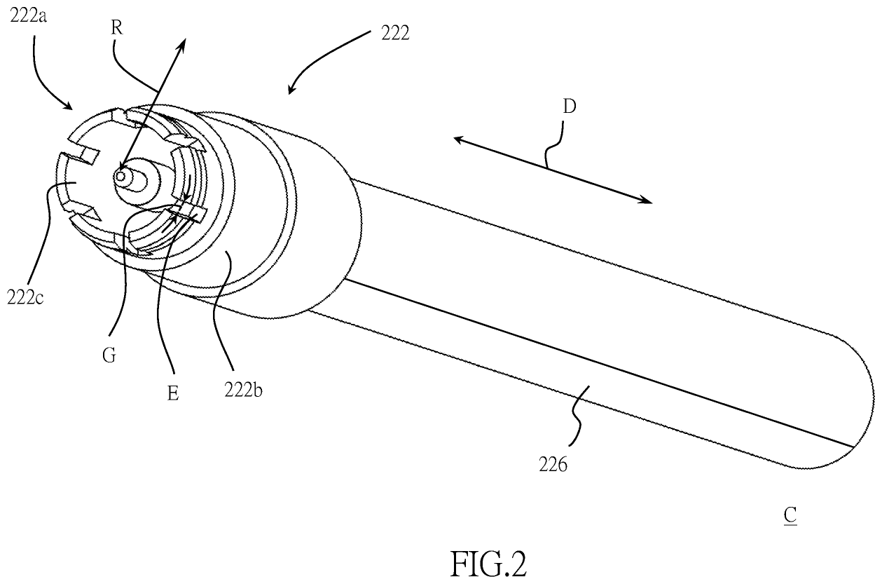

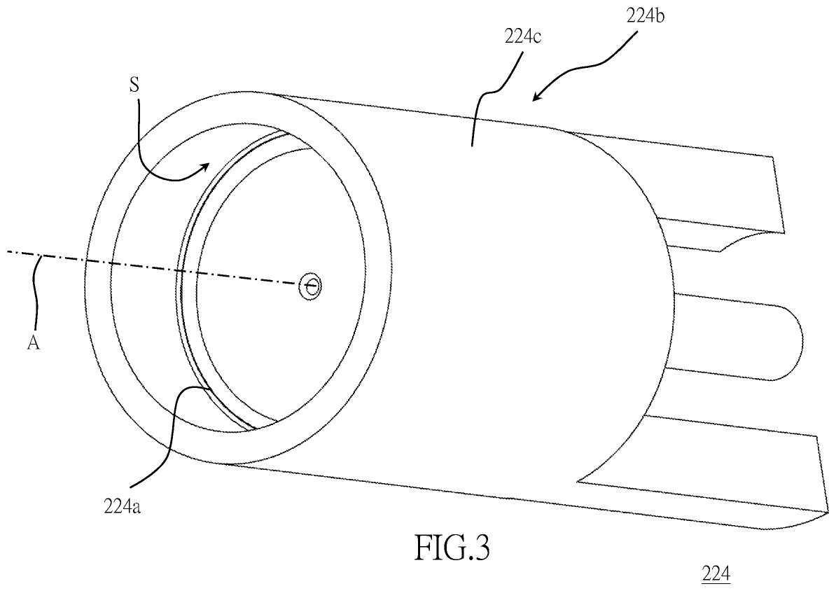

FIG. 2 shows a three-dimensional schematic diagram of the first connector 222 and coaxial cable 226 in FIG. 1. FIG. 3 shows a three-dimensional schematic diagram of the second connector 224 in FIG. 1. Referring to FIGS. 1 through 3, the first connector 222 of each of the coaxial cables C includes a first clip-locking portion 222a and a first body 222b. As shown in the drawings, the first body 222b has a tube-like shape (i.e., cylindrical in shape), and the first body 222b extends in a direction D. The first clip-locking portion 222a of each of the coaxial cables C is configured on the circumference of the corresponding first body 222b, and one end of the first clip-locking portion 222a of each of the coaxial cables C is adapted for being elastically deformed generally perpendicular to the direction D in which the first body 222b extends, e.g., for being elastically deformed generally along a direction R which is perpendicular to the direction D.

As shown in the drawings, the first clip-locking portion 222a of the first connector 222 of each of the coaxial cables C is similar to a clip, wherein the bottom of the first clip-locking portion 222a and the first body 222b of the first connector 222 of each of the coaxial cables C are fixedly connected or otherwise integral with one another, and the top end of the first clip-locking portion 222a may move outward and/or inward generally perpendicular to the direction D due to being acted on by a force, and may be restored to an original (default) condition when no force acts upon it. Further, it should be noted that, the first body 222b may also be in a shape other than being cylindrical in shape, for example, a hexagonal column in shape, a quadrilateral column in shape, or other types of polygon type shapes.

In some implementations, the first clip-locking portion 222a of each of the coaxial cables C includes one or more elastic locking hooks 222c (in a number that is not specifically limited). The locking hooks 222c are disposed on an edge E of the corresponding first body 222b, wherein the edge E may be a closed edge (e.g., an annular edge, but may also be an edge of a hexagon or an edge of a quadrilateral, etc.). A gap G is maintained between neighboring locking hooks 222c so as to avoid interference between the neighboring locking hooks 222c when the locking hooks 222c are deformed either inwardly or outwardly. One end of the coaxial cable body 226 of each of the coaxial cables C passes through the first body 222b of the corresponding first connector 222.

Each of the second connectors 224 may include a second clip-locking portion 224a and a second body 224b. The second clip-locking portion 224a of each of the second connector 224 is disposed on the corresponding second body 224b and is adapted for locking the corresponding first clip-locking portion 222a. In this embodiment, the second clip-locking portion 224a of each of the second connector 224 is a protrusion, which may be an annular protrusion (but may also be a dot-like, line-like, arc, L-shaped or V-shaped protrusion) disposed on an inner side S of the tube structure 224c of the corresponding second body 224b.

The first connector 222 of one coaxial cable C may be connected along an axial direction A of the tube structure 224c of the second body 224a of the corresponding second connector 224 and may be plugged with the corresponding second connector 224, so that the locking hooks 222c of the first connector 222 are pressed to be first elastically deformed perpendicularly to the direction D and then be inserted into the second clip-locking portion 224a of the corresponding second connector 224, thereby being clip-locked in the second clip-locking portion 224a of the corresponding second connector 224. Accordingly, each of the coaxial cable bodies 226 becomes electrically connected with the corresponding second connector 224. Further, another end of each of the coaxial cable bodies 226 away from the antenna box 210 may be selectively externally connected to another external device (not shown), for example, a network card of a host or a router.

Compared to the prior art, the method of assembling the first connectors 222 and the second connectors 224 of this embodiment does not require any additional tools or locking elements, so that the method of assembling the first connectors 222 and the second connectors 224 of this embodiment is more labor saving and time saving. Further, for a situation where the antenna box 210 has the plurality of antennas 214a and correspondingly needs a plurality of first connectors 222/second connectors 224 (e.g., eight first connectors 222/second connectors 224), the effect of this embodiment becomes even more significant. Furthermore, in some implementations, a plurality of first connectors 222 may be fixedly arranged at a common base (not shown) in an array form (e.g., one or more rows) to become a connector combination. When the first connectors 222 forming the connector combination are together plugged with a plurality of corresponding second connectors 224 (which may be arranged in a row and be disposed on the circuit board 214, or may also become another connector combination by means of a common base), quick plugging with non-precise alignment is permitted (i.e., a larger alignment error is allowed for assembly), hence appropriately reducing the requirement of alignment precision of connectors and further reducing production costs.

It should be noted that, in some implementations, each of the first connectors 222 may be disposed on the circuit board 214, and each of the second connectors 224 may be disposed on one end of the corresponding coaxial cable body 226 so that each of the second connectors 224 and the corresponding coaxial cable body 226 can form another coaxial cable, depending on requirements of a designer; however, this implementation is not expressly depicted in the drawings.

The opening 212a of the housing 212 may be located on a side surface 212b of the housing 212. In another implementation, the opening 212a may also be located on a top surface 212c of the housing 212 or a bottom surface opposite to the top surface 212c. When the second connectors 224 are located on the top surface 212c and/or the bottom surface of the housing 212, the second connectors 224 may be electrically connected to the circuit board 214 by means of welding or inserting.

In some implementations, the antennas 214a in FIG. 1 may be replaced (either in part or in whole) by one or more electronic elements of other functions. In other words, this implementation is not limited to an antenna box that includes antennas but may be an electronic device including a plurality of electronic elements (without an antenna function) of different functions, wherein each of the electronic elements is electrically connected to corresponding one(s) of the second connectors 224.

The present disclosure has one of the following advantages or other advantages. The method of assembling the first connectors and the second connectors of the embodiment of the present disclosure does not require additional tools or locking elements. Thus, compared to the prior art, the method of assembling the first connectors and the second connectors of the present disclosure is more labor and time saving. Further, in some implementations, a plurality of first connectors may be fixedly arranged at a common base in an array form. When the first connectors are together plugged with a plurality of corresponding second connectors, quick plugging with non-precise alignment is permitted (i.e., a larger alignment error is allowed for assembly), hence appropriately reducing the requirement of alignment precision of connectors and further reducing production costs.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

What is claimed is:

1. An antenna box module, comprising:
a circuit board having an antenna; and
a connector module, comprising:
a first connector, comprising a first clip-locking portion and a first body, wherein the first body has a tube shape and extends in a direction, the first clip-locking portion is disposed at the first body, and an end of the first clip-locking portion is adapted for being elastically deformed perpendicularly to the direction;
a second connector, comprising a second clip-locking portion and a second body, wherein the second clip-locking portion is disposed at the second body and adapted for locking the first clip-locking portion; and
a coaxial cable body, wherein an end of the coaxial cable body passes through only one of the first body and the second body, and the other of the first body and the second body is disposed at the circuit board and electrically connected to the antenna.

2. The antenna box module according to claim 1, wherein the first clip-locking portion has a plurality of locking hooks, the locking hooks are disposed at an edge of the first body, and a gap is maintained between neighboring two of the locking hooks.

3. The antenna box module according to claim 1, wherein the second clip-locking portion is a protrusion disposed at an inner side of a tube structure of the second body.

4. The antenna box module according to claim 1, wherein the connector module comprises a plurality of first connectors and a plurality of second connectors, and the first connectors are fixed at a common body to be arranged in an array and/or the second connectors are fixed at another common body to be arranged in an array.

5. A connector module, comprising:
a first connector, comprising a first clip-locking portion and a first body, wherein the first body has a tube shape and extends in a direction, the first clip-locking portion is disposed at the first body, and an end of the first clip-locking portion is adapted for being elastically deformed perpendicularly to the direction;
a second connector, comprising a second clip-locking portion and a second body, wherein the second clip-locking portion is disposed at the second body and adapted for locking the first clip-locking portion; and
a coaxial cable body, wherein an end of the coaxial cable body passes through only one of the first body and the second body, and the other of the first body and the second body is adapted for being disposed at a circuit board.

6. The connector module according to claim 5, wherein the first clip-locking portion has a plurality of locking hooks, the locking hooks are disposed at an edge of the first body, and a gap is maintained between neighboring two of the locking hooks.

7. The connector module according to claim 5, wherein the second clip-locking portion is a protrusion disposed at an inner side of a tube structure of the second body.

8. The connector module according to claim 5, comprising a plurality of first connectors and a plurality of second connectors, wherein the first connectors are fixed at a common body to be arranged in an array and/or the second connectors are fixed at another common body to be arranged in an array.

9. A coaxial cable, comprising;
a first connector, comprising a first clip-locking portion and a first body, wherein the first body has a tube shape and extends in a direction, the first clip-locking portion is disposed at the first body, and an end of the first clip-locking portion is adapted for being elastically deformed perpendicularly to the direction; and
a coaxial cable body, wherein an end of the coaxial cable body passes through the first body.

10. The coaxial cable according to claim 9, wherein the first clip-locking portion has a plurality of locking hooks, the locking hooks are disposed at an edge of the first body, and a gap is maintained between neighboring two of the locking hooks.

11. The coaxial cable according to claim 9, comprising a plurality of first connectors, wherein the first connectors are fixed at a common body to be arranged in an array.
